(19) United States
(12) Patent Application Publication
(10) Pub. No.: US 2025/0066234 A1
(43) Pub. Date: Feb. 27, 2025

(54) GLASS GOB DELIVERY SYSTEM

(71) Applicant: Owens-Brockway Glass Container Inc., Perrysburg, OH (US)

(72) Inventors: Stephen M. Graff, Maumee, OH (US); Karl Johnston, Perrysburg, OH (US)

(21) Appl. No.: 18/455,188

(22) Filed: Aug. 24, 2023

(51) Int. Cl. C03B 7/00; C03B 7/14

(52) U.S. Cl. CPC C03B 7/005; C03B 7/14

(57) ABSTRACT

A method includes observing a molten glass gob discharged from a transport cup and adjusting a fluid flow parameter of the transport cup based on an observed characteristic of the discharged glass gob.

### TECHNICAL FIELD

This patent application discloses innovations related to glass manufacturing and, more particularly, to distributing molten glass in a glass container manufacturing process.

### BACKGROUND

When manufacturing glass containers, discrete amounts of molten glass are systematically and repeatedly delivered from a furnace or a melter to a glass container forming machine. For example, the operation of an individual section glass container forming machine involves receiving a charge of molten glass in a blank mold of the machine, forming the charge of molten glass into a glass parison (i.e., a partially formed container) in the blank mold, transferring the glass parison to a blow mold of the machine, and forming the parison into a glass container within the blow mold. The charge of molten glass, often referred to as a “gob,” may be formed by shearing a segment of the desired amount from an extruded stream of molten glass produced at a glass feeder, which receives the glass from the furnace or melter, usually via a forehearth. Such a feeder typically feeds numerous blank molds of corresponding forming machines, and newly produced gobs must be continually delivered to the blank molds.

Glass container forming machines are conventionally supplied with glass gobs using a gob distribution system that includes a lengthy and widespread series of scoops, troughs, and deflectors. The scoops, troughs, and deflectors establish a guide track from the glass feeder to each of the blank molds of the various forming machines. The conventional gob distribution system can successfully distribute gobs on time to a multitude of glass container forming machines; however, the glass gobs tend to cool unevenly as the gobs slide through the system towards their respective forming machines since only a portion of the length of the gobs makes contact with the various interconnected scoops, troughs, and deflectors. The gobs received at the blank molds may, consequently, exhibit an inhomogeneous temperature profile around their circumference, which can cause non-uniform glass flow during the subsequent forming processes. The temperature profiles of glass gobs received at different blank molds may also vary as a result of the glass gobs having traveled different distances through the gob distribution system to their respective molds. Different approaches for delivering glass gobs to glass container forming machines would thus be of interest to the glass manufacturing community.

### SUMMARY OF THE DISCLOSURE

The present disclosure embodies a number of aspects that can be implemented separately from or in combination with each other.

A method in accordance with one aspect of the disclosure includes observing a molten glass gob discharged from a molten glass transport cup and adjusting a fluid flow parameter of the transport cup based on an observed characteristic of the discharged glass gob.

In accordance with another aspect of the disclosure, there is provided a method including the following steps: (a) observing a characteristic of a first glass gob discharged from a molten glass transport cup at a glass gob discharge location, (b) moving the transport cup to a glass gob receiving location after step (a), measuring a temperature of the transport cup after step (a), receiving a second glass gob in the transport cup at the receiving location after step (b), moving the transport cup containing the second glass gob to the discharge location after step (d), discharging the second glass gob from the transport cup after step (e), and moving the transport cup to the receiving location after step (f). A fluid flow parameter of the transport cup during at least one of steps (d) through (g) is regulated based on at least one of: the temperature measured in step (c), and the characteristic observed in step (a).

In accordance with another aspect of the disclosure, there is provided a glass gob delivery system including a transport cup that moves back and forth between a glass gob receiving location and a glass gob discharge location, and a camera that obtains an image indicative of a characteristic of a glass gob being discharged from the passage at the discharge location. The transport cup includes a porous wall at least partly defining a passage of the transport cup, and an endcap that covers an outlet of the passage at the receiving location and uncovers the outlet of the passage at the discharge location. A cooling gas flowrate into the passage through the porous wall and an endcap fluid flowrate into the passage through the endcap during receipt of a different glass gob into the transport cup at the receiving location is based at least in part on said characteristic.

### BRIEF DESCRIPTION OF THE DRAWINGS

FIG. 1 is a schematic view of an illustrative molten glass gob delivery system as part of a glass container manufacturing process;

FIG. 2 is an enlarged schematic view of a portion of the delivery system of FIG. 1, including a molten glass transport cup;

FIG. 3 is a schematic illustration of a glass delivery process cycle, including illustrative cooling gas and endcap fluid flow profiles;

FIG. 4 is a flow chart depicting an illustrative method associated with the disclosed delivery system;

FIG. 5 is a schematic side view of a glass gob having a nose with rounded corners;

FIG. 6 is a schematic side view of a glass gob having a square-cornered nose;

FIG. 7 is a schematic side view of a glass gob having a deformed nose;

FIG. 8 is a schematic side view of a glass gob having a non-uniform diameter;

FIG. 9 is a flow chart depicting an illustrative method associated with the disclosed delivery system; and

FIG. 10 is a flow chart depicting an illustrative method associated with the disclosed delivery system.

### DETAILED DESCRIPTION

Described below is a glass gob delivery system and related methods. The system is equipped to observe molten glass gobs during delivery and to adjust one or more process parameters based on those observations. Thermal and geometric characteristics of a glass gob observed at a discharge location can be used to adjust one or more fluid flow parameters of a transport cup used to receive, transport, and discharge a subsequent glass gob, thereby improving gob uniformity within the system.

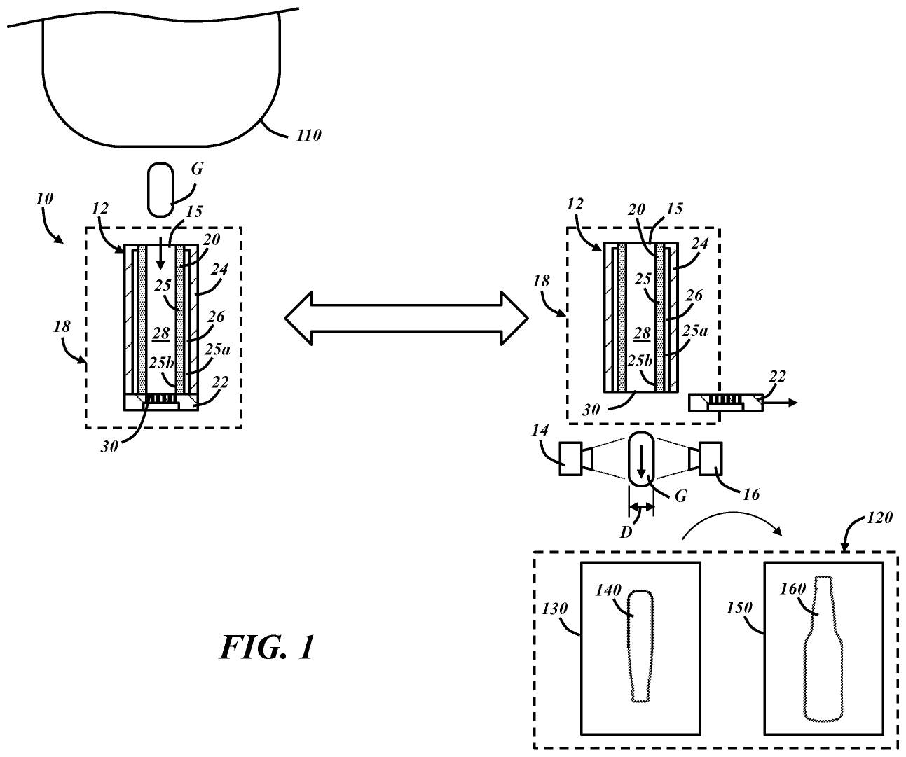

FIG. 1 schematically illustrates a portion of a glass container manufacturing process employing one embodiment of a molten glass gob delivery system 10 and an illustrative method of using the delivery system 10. The system 10 includes a molten glass transport cup 12 and one or more image sensors 14, 16 configured to obtain measurements of glass gobs during delivery. The transport cup 12 moves back and forth between a glass gob receiving location and one or more glass gob discharge locations. As shown in FIG. 1, the receiving location may be beneath a glass feeder 110, where the transport cup 12 is positioned to receive a molten glass gob G. The discharge location may be above a glass forming machine 120, where the transport cup 12 is positioned to discharge the glass gob G to be received by the glass forming machine 120. The illustrated forming machine 120 includes a blank mold 130 and a blow mold 150. The blank mold 130 receives the glass gob G from the transport cup 12 and has a cavity 140 in which the received glass gob is transformed into a glass parison. After being formed in the blank mold 130, the parison is transferred to the blow mold 150 and is formed into a glass container within a cavity 160 of the blow mold 150.

The image sensor(s) 14, 16 are arranged to observe the glass gob G upon discharge from the transport cup 12 at the discharge location. In the illustrated example, the glass gob G falls away from the transport cup 12 when discharged, and the image sensor(s) 14, 16 detect one or more characteristics of the glass gob G after it leaves the transport cup 12 and before the glass gob G is received by the glass forming machine 120. A process cycle of the delivery system 10 is defined between repeated events of the process. For example, a process cycle may begin with the transport cup 12 receiving a glass gob G at the receiving location and end when the transport cup 12 has returned to the receiving location from the discharge location and is ready to receive another glass gob G.

The transport cup 12 may be part of a molten glass transporter 18 that is mounted to a conveyor (not shown), such as a rail, frame, or gantry structure equipped with a linear drive motor or other suitable actuator and control system configured to move the transporter 18, and thus the transport cup 12, back and forth between the receiving location and the discharge location. Movement of the transporter 18 between the receiving and discharge locations need not be linear and may, for example, be along a curved path and/or include elevation changes. The timing of the movements of the transporter 18 may be coordinated with the timing of the glass feeder 110 and the glass forming machine 120 by a control strategy using controls hardware and related software. As another example, an automated and programmable robot capable of movement in three or more axes may be used to position the transporter 18 and move the transporter 18 back-and-forth between the receiving and discharge locations. The delivery system 10 may include one or multiple transporters 18, each of which may include one or multiple transport cups 12, and may even include multiple conveyors to support multiple transporters 18 (if multiple transporters are employed) to help ensure continual delivery of molten glass gobs G from the glass feeder 110 to the blank mold 130 of a single forming machine 120 or multiple forming machines.

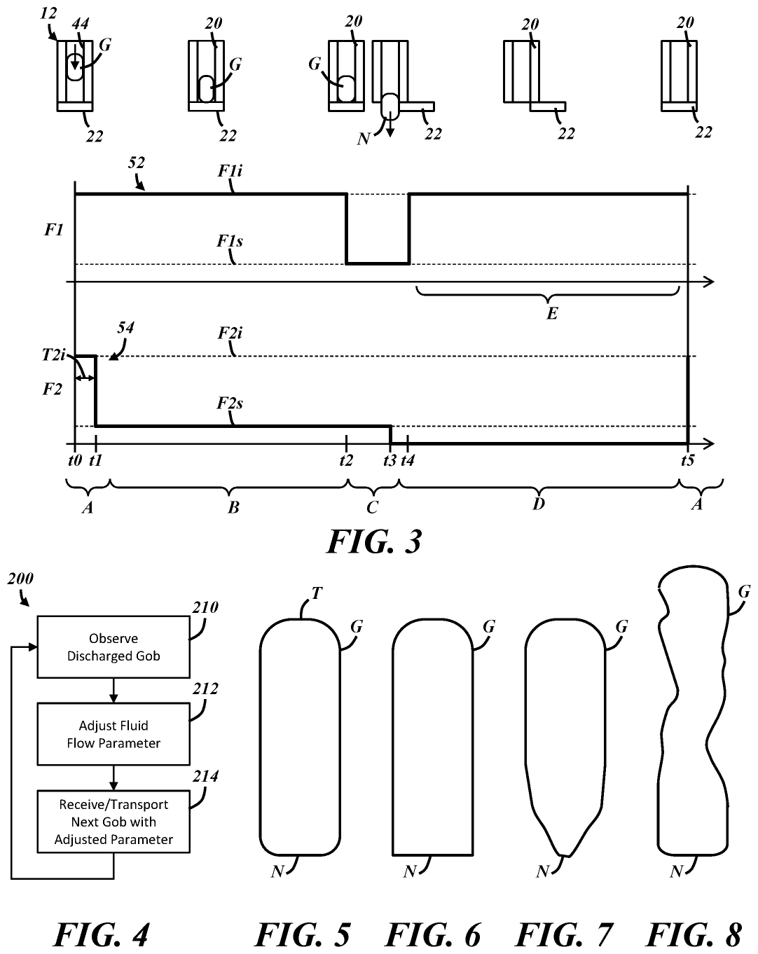

The transport cup 12 includes a transport guide 20, an endcap 22, and an outer sleeve 24 that at least partly defines an annular cooling chamber 26 between the transport guide 20 and the outer sleeve 24. The transport guide 20 is in the form of a cylindrical conduit 25 in this example and includes a porous wall 44 (FIG. 3). A cooling gas is supplied to the cooling chamber 26 and can be circulated in contact with a radially outer surface 25a of the porous wall 44 of the conduit 25. A radially inner surface 25b of the porous wall 44 of the conduit 20 at least partially defines and surrounds a passage 28 of the transport cup 12. The passage 28 provides and extends between an inlet 15 and an outlet 30 and, in operation of the transport cup 12, temporarily houses a received glass gob G during transport to the discharge location. The endcap 22 is moveable with respect to the conduit 25 between an open position, in which the outlet 30 of the passage 28 is uncovered by the endcap 22, and a closed position, in which the outlet 30 of the passage 28 is covered by the endcap 22.

In addition to the transport cup 12, each transporter 18 may include other unillustrated components, such as a conduit carrier, an endcap carrier, an endcap actuator for moving the endcap between the open and closed positions, an endcap guide to help define endcap motion, along with features that interface with the rail, robotic arm, or other structure along which the transporter 18 moves the transport cup 12 back and forth between the receiving and discharge locations. The transporter 18 may also provide at least a portion of the outer sleeve 24 or other wall defining the cooling chamber 26, along with connections for fluids that flow into, out of, or along the transport cup 12 and its passage 28. Suitable examples of molten glass transport cups 12, molten glass transporters 18, and related components and systems for use with the glass gob delivery system 10 disclosed herein are described in co-assigned U.S. patent application Ser. Nos. 18/113,754 and 18/113,925, both filed on Feb. 24, 2023, and each of which is hereby incorporated by reference in its entirety.

As illustrated in FIG. 1, the endcap 22 is in the closed position while the transport cup 12 is receiving a molten glass gob G at the receiving location and is in the open position during discharge of the glass gob G at the discharge location. The endcap 22 may be in either the open position or the closed position during movement between the receiving and discharge locations, depending in part on whether a glass gob G is being transported. For example, the endcap 22 may be in the closed position while receiving a gob G, remain in the closed position during movement of the transport cup 12 toward the discharge location, opened to the open position at the discharge location, and remain in the open position while moving back toward the receiving location. The endcap 22 may be returned to the closed position at the receiving location prior to the transport cup 12 receiving another glass gob G. It is also possible to move the endcap 22 back to the closed position after gob discharge and before or during movement of the transport cup 12 back to the receiving location.

In FIG. 1, the endcap 22 is schematically illustrated as moving laterally away from the conduit 25 to the open position so that the glass gob G can be discharged. This movement is meant to be representative of the many types of movement that may employed to move the endcap 22 to the open position. The endcap 22 may, for example, have a two-piece construction in which first and second endcap portions move in laterally opposite directions from the closed position to the open position to permit discharge of the glass gob G. Or the endcap 22 may have a trapdoor-like construction in which part or all of the endcap 22 pivots open to discharge the glass gob G or the endcap 22 may swing laterally away from the conduit 25. Other arrangements are possible.

Each image sensor 14, 16 is configured to observe and obtain information about one or more characteristics of a discharged glass gob G as the gob moves away from the transport cup 12 and toward the glass forming machine 120. Each characteristic may be a thermal characteristic or a geometric characteristic, such as a shape, profile, or dimension. In one embodiment, each image sensor 14, 16 is a camera that obtains an image of the discharged glass gob G. In a specific embodiment, one of the image sensors 14 is an optical camera that obtains an optical image of the discharged glass gob G, and another of the image sensors 16 is a thermal camera that obtains a thermal image of the discharged glass gob G. In some embodiments, the delivery system 10 includes multiple optical and/or thermal cameras arranged at different radial positions with respect to the discharged glass gob G. In other embodiments, only the thermal camera 16 is used to obtain thermal images from which both thermal characteristics and geometric characteristics can be determined.

One or more fluid flow parameters of the transport cup 12 may be adjusted or regulated based on information obtained from the image sensors 14, 16. Specifically, a fluid flow parameter of the transport cup 12 may be adjusted for a process cycle relative to a previous process cycle in which the discharged glass gob G was observed. Fluid flow parameters may be adjusted for a subsequent movement of the transport cup 12 back to the receiving location, for a subsequent receipt of a next glass gob G, for a subsequent movement of the transport cup 12 toward the discharge location with the next glass gob G, and/or for a discharge of the next glass gob G, at which time each image sensor 14, 16 observes the next glass gob G to enable continued monitoring and adjustments of the delivery system 10 and its process parameters.

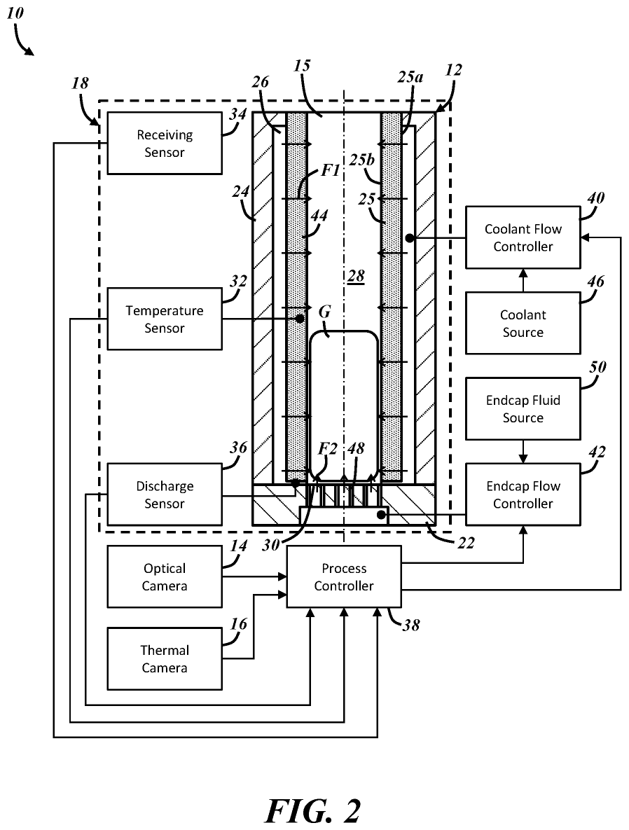

FIG. 2 schematically illustrates additional components of the illustrative delivery system 10. In addition to the image sensor(s) 14, 16, the illustrated system 10 includes a temperature sensor 32, a gob receiving sensor 34, and a gob discharge sensor 36. Each sensor 14, 16, 32, 34, 36 is in communication with a process controller 38, which receives signals that transmit observed information from the sensors 14, 16, 32, 34, 36 and controls the one or more fluid flow parameters of the transport cup 12 based at least in part on those signals. In this case, the controller 38 adjusts or regulates a first fluid flow F1 into the transport cup passage 28 via a first fluid flow controller 40, and a second fluid flow F2 into the passage 28 via a second fluid flow controller 42, as discussed in more detail below. In the examples discussed herein, the first fluid flow F1 is a cooling gas flow, and the second fluid flow F2 is an endcap fluid flow.

The temperature sensor 32 is arranged to detect a temperature of the transport cup 12. In this example, the temperature sensor 32 specifically detects the temperature of the conduit 25, preferably at the radial inner surface 25b closer to the outlet 30 of the passage 28 than to the inlet 15 of the passage 28. The temperature sensor 32 may be configured to continuously provide temperature information throughout each process cycle, during one or more discrete portions of each process cycle, or at one or more discrete times during each process cycle. The process controller 38 may be in two-way communication with the temperature sensor 32 to both query the sensor and receive signals from the sensor 32. Any suitable temperature sensor 32 may be employed, such as a thermocouple, thermistor, RTD or infrared thermometer. In one example, the temperature sensor is a two-color pyrometer. The temperature sensor 32 may be located on and move with the transport cup 12 or transporter 18, may be located at the receiving or discharge location, or may be located at a location between the receiving and discharge locations to take temperature readings of the conduit 25 at the respective location.

The gob receiving sensor 34 and gob discharge sensor 36 are configured to detect when a glass gob G has been respectively received in or discharged from the passage 28 of the transport cup 12. Each of the gob receiving and discharge sensors 34, 36 may be mounted to and move with the transport cup 12 or transporter 18. Or the gob receiving sensor 34 may be fixed at the receiving location, and the gob discharge sensor 36 may be fixed at the discharge location. In FIG. 2, the discharge sensor 36 is schematically depicted at a location within the transport cup 12 from which the gob G can be observed through an axial gap between the endcap 22 and the conduit 25. The receiving sensor 34 can be similarly arranged at the opposite end of the conduit 25, or one or both sensors 34, 36 can be axially spaced from the ends of the conduit 25. Any type of sensor capable of detecting the presence and/or movement of a glass gob G into or out of the transport cup 12 may be employed, such as a proximity sensor, ultrasonic sensor, etc. In one example, each sensor 34, 36 is a photodiode or other light sensor able to detect the light emitted from the molten glass gob G when passing into or out of the transport cup 12. In another embodiment, one of the image sensors 14, 16 may also double as the gob discharge sensor 36.

The process controller 38 receives signals from the gob receiving and discharge sensors 34, 36 and can thereby track and be aware as to whether a glass gob G is presently in the transport cup 12. The controller 38 may toggle a system condition between a “gob-in-cup” condition and a “no gob-in-cup” condition and communicate that condition with other parts of the system 10 or glass container manufacturing process. The controller 38 may, for example, prevent a glass gob G from being received at the receiving location if the gob discharge sensor 36 did not detect a previously received gob having been discharged from the transport cup 12 at the discharge location—that is, if the system condition has a gob-in-cup condition after returning to the receiving location from the discharge location. Information from the gob receiving and discharge sensors 34, 36 can also be used by the controller 38 to make adjustments to the first and second fluid flows F1, F2 as discussed in more detail below.

The cooling gas flow F1 into the passage 28 of the transport cup 12 is a permeating fluid flow from the cooling chamber 26 and through the porous wall 44 of the conduit 25. The conduit wall 44 is porous in the sense that it exhibits a non-zero gas permeability. In one embodiment, the porous wall 44 of the conduit 25 is formed from a graphite material. The permeating fluid flow F1 into the passage 28 is a diffuse fluid flow through the interstitial porosity of the microstructure of the porous wall 44 and thus may have non-radial directional components. The cooling chamber 26 is in fluidic communication with a source of cooling gas 46 via the first fluid flow controller 40, which is a cooling gas flow controller in the illustrated example, and is pressurized with the cooling gas. The transport cup 12 and/or transporter 18 may include one or more cooling gas inlet ports and cooling gas outlet ports through which the cooling gas flows into and out of the cooling chamber 26, respectively. The cooling gas may be air, nitrogen, or any other gas capable of extracting heat from the conduit 25 as it passes through the cooling chamber 26 and flows permeably through the porous wall 44. The cooling gas flow controller 40 is capable of changing the flowrate of the cooling gas flow F1, which, here, is the flowrate of the cooling gas permeably into the passage 28. The flowrate may be a mass flowrate or volumetric flowrate and may be indirectly controlled by regulating the pressure of the cooling gas in the cooling chamber 26. In one embodiment, the cooling gas flow controller 40 is a voltage-controlled regulator, and the process controller 38 controls the cooling gas flowrate by controlling the voltage provided to the regulator.

The endcap fluid flow F2 into the passage 28 of the transport cup 12 is a fluid flow directly into the passage through the endcap 22 when the endcap 22 is covering the outlet 30 of the passage 28 in the closed position. To facilitate the endcap fluid flow F2, one or more fluid passages 48 may be formed through the endcap 22. The fluid passages 48 are in fluidic communication with an endcap fluid source 50 via the second fluid flow controller 42, which is an endcap flow controller in the illustrated example. The transport cup 12 and/or transporter 18 may include one or more fluid inlet ports through which the endcap fluid flows into the fluid passages 48. While not shown in FIG. 2, the transport cup 12 may also include one or more fluid outlet ports—near an interface of the conduit 25 and endcap 22, for example—or a venting gap between the conduit 25 and the endcap 22 when the endcap 22 is in the closed position to permit endcap fluid to escape the passage 28 when a glass gob G is in the passage 28. The endcap fluid is preferably a gas, such as air, nitrogen, or an inert gas, for example. The endcap flow controller 42 is capable of changing the flowrate of the endcap fluid flow F2, which, here, is the flowrate of the endcap fluid into the passage 28 through the fluid passage(s) 48 of the endcap 22. The flowrate may be a mass flowrate or volumetric flowrate. In one embodiment, the endcap fluid flow controller 42 is a proportional valve that controls the endcap fluid flow F2 via a flow restrictor that changes size in proportion to an applied voltage, which is controlled by the process controller 38.

The first and second fluid flows F1, F2 work together to reduce or minimize physical contact between the transport cup 12 and the glass gob G during receipt of the glass gob at the receiving location and during transport of the glass gob G to the discharge location. Each fluid flow F1, F2 provides a fluidic cushion between surfaces of the transport cup 12 and the glass gob G so that heat loss from the glass gob G can be disrupted. The cooling gas flow F1 provides a circumferentially and axially extending gas cushion between the glass gob G and the inner surface 25b of the porous wall 44 of the conduit 25. The endcap fluid flow F2 provides a fluid cushion axially between the endcap 22 of the transport cup 12 and the glass gob G. While these fluidic cushions do not necessarily prevent all contact of the received glass gob G with respective surfaces of the transport cup 12, such contact may be only intermittent rather than continuous, as would be the case without the two fluid flows F1, F2. Heat loss from the glass gob G to the solid materials of the transport cup 12 is thus minimized so that each glass gob G retains as much thermal energy as possible when delivered to the glass forming machine 120, thus helping to improve the consistency of glass flow in the glass forming machine 120.

FIG. 3 schematically illustrates an illustrative process cycle of the gob delivery system 10 along with illustrative fluid flow profiles of the first and second fluid flows F1, F2, which are the respective cooling gas flow and endcap fluid flow in this example. The cooling gas flow profile 52 is for the cooling gas flow F1 permeably through the porous wall 44 of the conduit 25 and includes an initial fluid flowrate F1i and a secondary fluid flowrate F1s that is less than the initial flowrate F1i. The endcap fluid flow profile 54 is for the endcap fluid flow F2 through the endcap 22 of the transport cup 12 and includes an initial fluid flowrate F2i and a secondary fluid flowrate F2s that is less than the initial flowrate F2i. The horizontal direction of each profile 52, 54 represents time or cumulative distance traveled from a reference point to. Additionally, the illustrated process cycle includes periods A-E. The transport cup 12 is at the receiving location during period A, moving toward the discharge location during period B, at the discharge location during period C, and moving toward the receiving location during period D. The cooling period E is within period D in this example.

The illustrated process cycle starts with the transport cup 12 at the receiving location during time period A. At the start of the process cycle, the endcap 22 of the transport cup 12 is in the closed position and both fluid flows F1, F2 are at their initial flowrates F1i, F2i. The endcap fluid flow F2 is at the initial endcap fluid flowrate F2i when the molten glass gob G first enters the passage 28 of the conduit 25 of transport cup 12 through the inlet 15, and then changes to the secondary endcap fluid flowrate F2s at t1 when the received gob G contacts the endcap 22 or before the received gob G contacts the endcap 22. The initial endcap fluid flowrate F2i works to reduce the velocity of the glass gob G so that the gob G does not impact the endcap 22 with high kinetic energy, which would tend to cause a relatively large amount of thermal energy to be transferred from the gob G to the endcap 22. But as the initial endcap fluid flow F2 slows the gob G, a point is reached when the high initial endcap fluid flowrate F2i will force the gob G back out of the conduit 25, or at least lift the glass gob G too far away from the endcap 22, if the flowrate is not reduced. The transition to the lower secondary endcap fluid flowrate F2s acts to prevent ejection of the gob G from the transport cup 12 or excessive lift of the gob G within the transport cup 12 while minimizing the speed at which the gob reaches the endcap 22.

In a non-limiting example, the transport cup 12 is configured to provide a maximum endcap fluid flowrate in a range from 2 g/s to 4 g/s based on an endcap fluid source at 60 psi. The initial endcap fluid flowrate F2i may be in a range from 30% to 100% of the maximum flowrate, and the secondary endcap fluid flowrate F2s may be in a range from 40% to 70% of the maximum flowrate. The initial and secondary endcap fluid flowrates F2i, F2s may be within ±10-20% of each other with respect to the maximum flowrate and may vary based on gob weight, gob geometry, and permeability of the conduit 25. In some cases, the initial endcap fluid flowrate F2i can be equal to or less than the secondary endcap fluid flowrate F2s because the cooling gas flow F1 through the conduit 25 can have a decelerating effect on the gob G during receipt of the gob G into the transport cup 12. The duration of the initial endcap fluid flowrate F2i may be in a range from 0.3 to 0.4 seconds and is dependent to some degree on the time required for the flowrate F2i to reach steady-state.

Once the glass gob G is received by the transport cup 12, as indicated by the gob receiving sensor 34 of FIG. 2, for example, the transport cup 12 containing the gob G is moved toward the discharge location during period B of the process cycle. During period B, the cooling gas flow F1 is maintained at the initial cooling gas flowrate F1i and the endcap flow F2 is maintained at the secondary endcap fluid flowrate F2s to provide the aforementioned fluidic cushions around and under the gob G during transport to the discharge location and, in the case of the cooling gas flow F1, to continue to cool the conduit 25 of the transport cup 12 while moving to the discharge location. The secondary endcap fluid flowrate F2s may be referred to as the “sustain” flowrate, as it maintains the fluidic cushion without forcing the gob G too far toward the inlet 15 of the passage 28.

While the transport cup 12 is at the discharge location during time period C, the endcap 22 is moved to the open position at t3 to discharge the gob G out of the passage 28 and from the transport cup 12 for receipt by the glass forming machine 120. Here, the endcap fluid flow F2 effectively falls to zero even if fluid continues to flow through the fluid passages 48 of the endcap 22 since the endcap 22 is no longer covering the outlet 30 of the passage 28. Before that, however, the cooling gas flow F1 is reduced to the secondary cooling gas flowrate F1s at t2. This reduction in the cooling gas flow F1 before the gob G is discharged from the conduit 25 allows the gob G to relax and expand radially into contact with the radial inner surface 25b of the porous wall 44 of the conduit 25 just before and during discharge. This brief relaxation of the glass gob G and the resultant physical contact with the porous wall 44 helps ensure that the gob G is at or near its maximum diameter to be guided along a predictable trajectory as it leaves the transport cup 12.

In the illustrated example, the reduction in the cooling gas flow F1 to the secondary cooling gas flowrate F1s coincides with the time t2 at which the transport cup 12 reaches the discharge location, but this is not always the case. For example, t2 may occur near the end of period B of the cycle, before the transport cup 12 reaches the discharge location, and movement of the endcap 22 to the open position may occur at the same time the transport cup 12 reaches the discharge location. Additionally, the process controller 38 (FIG. 2) may operate to change to the secondary cooling gas flowrate F1s earlier than the time at which the full reduction in flowrate is realized. This may be necessary due to the porous wall 44 causing an extended decay time between the initial and secondary cooling gas flowrates F1i, F1s.

Once the glass gob G is discharged from the transport cup 12, as indicated by the gob discharge sensor 36 of FIG. 2, for example, the empty transport cup 12 is moved toward the discharge location during period D of the process cycle. During period D, the cooling gas flow F1 may be returned to the initial cooling gas flowrate F1i to help cool the conduit 25 of the transport cup 12 before the cup 12 arrives at the discharge location to receive another glass gob G. This increase in the cooling gas flowrate at t4 may occur after the transport cup 12 begins moving toward the receiving location as shown in FIG. 3, or it may occur after gob discharge and before period D. In some cases, the cooling gas flowrate in period D is higher than the initial cooling gas flowrate F1i, such as when additional cooling of the conduit 25 is required to bring the temperature of the conduit 25 within the desired temperature range prior to receiving the next glass gob G. The endcap 22 may remain in the open position during movement of the transport cup 12 to the receiving location, as shown in FIG. 3. Alternatively, the endcap 22 may be changed to the closed position before or during movement of the transport cup 12 to the receiving location, if desired.

In the illustrated example, the endcap 22 is moved back to the closed position after the transport cup 12 reaches the receiving location. FIG. 3 illustrates a small delay between the time the transport cup 12 reaches the receiving location and the time t5 at which the endcap 22 is closed and the endcap fluid flow F2 is returned to the higher initial endcap fluid flowrate F2i. During that delay, the temperature of the conduit 25 can be measured to gauge the effectiveness of the cooling gas flow F1 on cooling the conduit 25 during the most recent movement of the transport cup 12 to the receiving location. Time t5 is effectively time t0 for the next process cycle.

It should be noted that FIG. 3 is merely one example of fluid flow profiles associated with the transport cup 12 and relative timing of events during a process cycle. For example, changes in fluid flowrates may be other than the illustrated step-changes and may instead be continuous functions of time or may include more than two discrete flowrates. These simplified schematics are provided for ease in understanding the various methods of using the disclosed glass gob delivery system 10 provided below. Moreover, while the description below treats transport cup fluid flow rates and the timing in changes of those flowrates as the only fluid flow parameters that are adjusted or regulated in response to observations of discharged glass gobs G and in-process temperatures, other related process parameters can also be adjusted or regulated based on these observations.

With reference to FIG. 4, an illustrative method 200 consistent with the above-described glass gob delivery system 10 includes observing a molten glass gob G (step 210) discharged from the molten glass transport cup 12, and adjusting a fluid flow parameter (step 212) of the transport cup 12 based at least in part on an observed characteristic of the discharged glass gob G. The method may additionally include receiving and transporting another glass gob G (step 214) in the transport cup 12 using the adjusted fluid flow parameters, and then repeating the observation and adjustment with each glass gob G received and discharged from the transport cup 12.

As used herein, observation of the discharged glass gob G may include observation by a person, observation, measurement, or interpretation by a machine, or observation by a person using a machine. In other words, the sensors 14, 16, 32, 34, 36 and process controller 38 of FIG. 2 are not strictly necessary to practice the method of FIG. 4. For instance, a person may be able to visually gauge a characteristic of a discharged glass gob G, such as the timing of the discharge relative to movement of the endcap 22 to the open position. And, in response, that person may adjust the cooling gas flow F1 and/or endcap fluid flow F2 of the transport cup 12 to improve upon or otherwise affect the timing of the next glass gob discharge consistent with the teachings contained herein.

In various embodiments, step 210 includes obtaining an image of the glass gob G when discharged from the transport cup 12 using the one or more image sensors 14, 16 as illustrated in FIG. 1. Where observation of the discharged gob G includes obtaining an image, the type of image obtained should be indicative of the characteristic upon which the adjustment of step 212 is based. The characteristic may be a thermal characteristic or a geometric feature of the gob G. While those characteristics and related adjustments to fluid flow parameters are the primary focus of the examples below, other characteristics may be observed to inform adjustments in the fluid flow parameters of the transport cup 12, such as a dynamic characteristic (e.g., velocity) or a chemical characteristic.

One example of a geometric feature that can be observed and upon which fluid flow parameter adjustments may be based is the transverse width (e.g., diameter D) (FIG. 1) of the gob G. The gob diameter D can be determined from an optical image taken by an optical camera and may be indicative of whether the gob G was able to reach a maximum diameter upon discharge from the transport cup 12, which has some processing advantages as noted above. In one embodiment, the cooling gas flow profile 52 of the cooling gas flow F1 is adjusted based on the diameter D of the discharged gob G. With reference to FIG. 3, the secondary cooling gas flowrate F1s may be decreased if the observed diameter D of the previously discharged gob G is less than desired. The decrease in the secondary cooling gas flowrate F1s can permit the gob G to expand radially to a greater extent prior to and during discharge from the transport cup 12. Alternatively or additionally, the timing of the transition (at t2 in FIG. 3) from the initial cooling gas flowrate F1i to the secondary cooling gas flowrate F1s can be adjusted to affect gob diameter D. Adjusting this transition such that it happens sooner (to the left in FIG. 3) can allow more time for the gob G to expand radially prior to discharge.

The effect works in the opposite direction as well, with an increased secondary cooling gas flowrate F1s and/or a delayed transition from the initial cooling gas flowrate F1i to the secondary cooling gas flowrate F1s leading to reduced gob diameter D. In some cases, an iterative process can be used to maximize discharged gob diameter D. For instance, if the gob diameter D is at an apparent maximum diameter, fluid flow parameter changes tending to decrease the diameter D can be made until gob diameter D begins to decrease such that threshold values or combinations of values for the initial and secondary cooling gas flowrates F1i, F1s can be identified.

One example of a thermal characteristic that can be observed and upon which fluid flow parameter adjustments may be based is a temperature or temperature profile of the gob G. Thermal characteristics can be determined from a thermal image taken by a thermal camera and may be indicative of whether the gob G has had excessive physical contact or rapid impact with interior surfaces of the transport cup 12 during receipt and/or transport of the gob G. Relatively low gob surface temperatures along the entire (axial) length of the gob G may indicate excessive physical contact between the gob G and the radially inner surface 25b of the porous wall 44 of the conduit 25 prior to gob discharge. Also, a relatively high temperature differential along the length of the gob G may indicate that some portions of the gob G had more contact with the radially inner surface 25b of the porous wall 44 prior to gob discharge than did other portions of the gob G.

In one embodiment, the cooling gas flow profile 52 of the cooling gas flow F1 is adjusted based on a temperature of the discharged gob G. For example, with continued reference to FIG. 3, the initial cooling gas flowrate F1i may be increased if the observed gob temperature is lower than desired along most of the length of the gob G. This increase can ensure a fluidic cushion is formed around the gob G while the gob G is being transported from the receiving location to the discharge location and thereby help minimize thermal energy loss to the conduit 25. Another change to the cooling gas flow profile 52 that may affect the observed temperature of the discharged gob G along most or all of its length is the timing of the transition from the initial cooling gas flowrate F1i to the secondary cooling gas flowrate F1s. For example, if the transition occurs too early, the gob G may experience excessive contact with the radially inner surface 25b of the porous wall 44 of the conduit 25, and an adjustment to delay that transition may be used to address low overall gob temperatures.

Alternatively or additionally, the endcap fluid flow profile 54 of the endcap fluid flow F2 is adjusted based on a temperature or temperature profile of the discharged gob G. For example, the initial endcap fluid flowrate F2i and/or the secondary endcap fluid flowrate may be increased if the observed gob temperature is lower at a nose N of the gob G (FIG. 3) compared to other portions of the gob G than desired. The nose N of the gob is the portion of the gob G closest to the endcap 22 of the transport cup 12 and the first portion of the gob G to exit the transport cup 12 during discharge. A “cold nose” gob condition can result from the gob G having experienced excessive contact with the endcap 22 during movement of the transport cup 12 from the receiving location to the discharge location. An increase in the secondary endcap fluid flowrate F2s can help remedy this condition. A cold nose gob condition may also result from the gob G impacting the endcap 22 with excessive kinetic energy during receipt of the gob G by the transport cup 12, even if the secondary endcap fluid flowrate F2s is sufficient to provide a fluidic cushion between the gob G and the endcap 22 during transport to the discharge location. In this case, an increase in the initial endcap fluid flowrate F2i can help remedy the cold nose condition. Another change in the endcap fluid flow profile 54 that can help remedy a cold nose condition is a change in the timing of the transition from the initial endcap fluid flowrate F2i to the secondary endcap fluid flowrate F2s. For instance, if the transition is made too early, the gob G may not have sufficiently slowed to prevent a high velocity impact with the endcap 22, and a delay in the transition to the secondary endcap fluid flowrate F2s may be in order.

The endcap fluid flow profile 54 may also be adjusted in response to other observations of a previously discharged gob G. For example, it may be desirable that the glass gob G makes contact with the endcap 22 of the transport cup 12 during receipt of the gob G into the cup 12, but with its velocity sufficiently reduced to prevent a cold nose condition. Whether the gob G has made sufficient contact with the endcap 22 can be determined in part from the shape of the discharged gob G. Sufficient contact with the endcap 22 during the gob receiving step and/or during transport to the discharge location may be indicated by the nose N of the gob G having a flat central portion with slightly rounded corners and without substantial distortion of the rest of the gob G, as schematically illustrated in FIG. 5. The example of FIG. 6 depicts a glass gob G having a nose N with sharp corners, which indicates that the gob G had more contact with the endcap 22 during the gob receiving step and/or during movement of the transport cup to the discharge location than the gob G of FIG. 5.

FIG. 7 schematically illustrates a discharged gob G that either did not make full contact with the endcap 22 during receipt of the gob G into the transport cup 12, or made contact with the endcap 22 during the receiving step but was deformed during transport to the discharge location by the endcap fluid flow F2. Rather than the slightly rounded corners where the endcap 22 confronts the radially inner surface 25b of the porous wall 44 of the conduit 25 in FIG. 5, the nose N of the gob G in FIG. 7 is deformed with almost no flat central portion and with a non-uniform diameter along a substantial length of the nose N. To remedy this condition, if such a remedy is desired, the endcap fluid flow profile 54 may be adjusted. In particular, one or both of the initial endcap fluid flowrate F2i and the secondary endcap fluid flowrate F2s may be reduced to permit the nose N of the gob G to make contact with the endcap 22 in a manner that eliminates the deformed portion or large radii from the nose N of the gob G of FIG. 7 or to reduce the distance that the gob G is held away from the endcap 22 during transport to the discharge location. An observed gob G having a deformed nose N as in FIG. 7 may result from an initial endcap fluid flowrate F2i that permits contact of the received gob with the endcap 22, but a secondary endcap fluid flowrate F2s that is too high and deforms the corners of the nose N of the gob G. In cases where the gob G is held away from and out of contact with the endcap 22, the nose N of the gob G may have little or no flat central portion as in FIG. 7.

FIG. 8 schematically illustrates a discharged gob G that became lodged in the passage 28 of the conduit 25 during the gob receiving step, causing excessive elongation of the gob G and a non-uniform diameter. This can result from an initial endcap fluid flowrate F2i that is too high. Embodiments of the method may thus include adjusting the endcap fluid flow profile 54 based on an observed length or an observed non-uniformity in the diameter D of a discharged gob G. Specifically, the adjustment may include decreasing the initial endcap fluid flowrate F2i.

The endcap fluid flow profile 54 may also be adjusted in response to a signal or the absence of a signal from the gob receiving sensor 34. For instance, an excessive initial endcap fluid flowrate F2i can prevent the gob G from being received in the passage 28 of the conduit 25 of the transport cup 12. Also, an excessive secondary endcap fluid flowrate F2s can force the gob G back out of the passage 28 at least partially past the inlet 15, resulting in the gob receiving sensor 34 generating an additional signal before any signal from the gob discharge sensor 36. In each case, the initial and secondary endcap fluid flowrates F2i, F2s can be lowered to address the problem.

Another example of a characteristic of a discharged gob G that can be observed and upon which fluid flow parameter adjustments may be based is the timing of the discharge, which can be observed by the gob discharge sensor 36 and/or one of the image sensors 14, 16. A glass gob G is considered discharged when its full length is out of the transport cup 12 and, thus, is beyond the outlet 30 of the passage 28 of the conduit 25. The process controller 38 may determine discharge speed as an elapsed time, with respect to a reference time, at which the full length of the gob G has passed the gob discharge sensor 36 or at which a reference point along the gob G reaches another reference point in a captured image of the gob G. Discharge speed may be determined, for example, when a tail T of the gob G (FIG. 5) reaches a fixed reference point of one of the image sensors 14, 16.

In one embodiment, the cooling gas flow profile 52 is adjusted based on the timing of the gob discharge. For example, a lower secondary cooling gas flowrate F1s can lead to a slower discharge due to the radial expansion of the gob G at the transition from the initial cooling gas flowrate F1i to the secondary cooling gas flowrate F1s. Too slow of a discharge speed can lead to a late delivery of the gob G to the glass forming machine 120, and an increase in the secondary cooling gas flowrate F1s can help alleviate such late deliveries.

In another embodiment, the endcap fluid flow profile 54 is adjusted based on the timing of the gob discharge. For example, the amount the secondary endcap fluid flowrate F2s spaces the gob G from the endcap 22 just before the endcap 22 is moved to the open position can affect the discharge speed. In some cases where the secondary endcap fluid flowrate F2s is too high, a slower discharge results because of the additional distance the gob G must travel to exit the transport cup 12. In some cases where the secondary endcap fluid flowrate F2s is too high, the gob G is initially lifted away from the endcap 22 but is already moving down when the endcap moves to the open position. This initial velocity can cause the full length of the gob G to be out of the passage 28 of the conduit 25 sooner than would a stationary gob lying at a lower position in the passage 28 when the endcap 22 is moved to the open position. This can lead to an early delivery of the gob G to the glass forming machine 120. In both cases, the secondary endcap fluid flowrate F2s may be reduced to adjust the discharge timing.

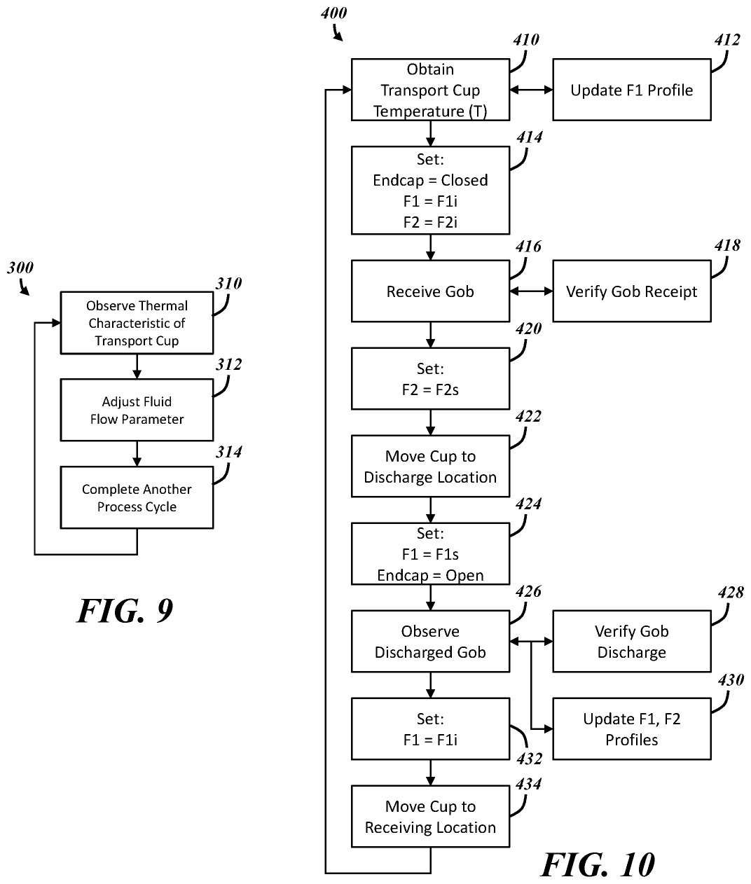

One or more transport cup fluid flow characteristics may also be adjusted or regulated based on a thermal characteristic of the transport cup 12. With reference to FIG. 9, an illustrative method 300 consistent with the above-described glass gob delivery system 10 includes observing a thermal characteristic (step 310) of the transport cup 12 during a process cycle, and adjusting a fluid flow parameter (step 312) of the transport cup 12 based at least in part on the observed thermal characteristic. The method may additionally include completion of another process cycle (step 314) with the transport cup 12 using the adjusted fluid flow parameter, and then repeating the observation and adjustment with each subsequent process cycle.

In one embodiment, the thermal characteristic is a temperature of the transport cup 12 obtained using the temperature sensor 32 depicted in FIG. 2. For example, the temperature of the conduit 25 of the transport cup 12 and, more preferably, the radially inner surface 25b of the porous wall 44, may be obtained at some point during a process cycle or at multiple points during the process cycle, and the cooling gas flow profile 52 may be adjusted based on the observed temperature(s). In a specific example, the temperature of the conduit 25 is measured when the transport cup 12 reaches the receiving location after discharging a glass gob G and before the endcap 22 is moved back to the closed position—i.e., before time t5 in FIG. 3 and at the beginning of a new period A of the transport cup 12 at the receiving location. The cooling period E (FIG. 3) may be defined beginning at the transition (at t4) from the secondary cooling gas flowrate F1s to the initial cooling gas flowrate F1i and ending at the beginning of period A.

Based on the temperature of the transport cup 12 observed at the end of the cooling period E, the initial cooling gas flowrate F1i may be adjusted for the next process cycle and/or the timing of the transition (t4) may be adjusted for the next process cycle to increase or decrease the length of the cooling period E. For example, if the observed temperature is higher than a desired temperature range, the initial cooling gas flowrate F1i may be increased for the next process cycle and/or the length of the cooling period E may be increased for the next process cycle. Conversely, if the observed temperature is lower than a desired temperature range, the initial cooling gas flowrate F1i may be decreased for the next process cycle and/or the length of the cooling period E may be decreased for the next process cycle by delaying the transition t4. A conduit 25 that is too hot, particularly at the radially inner radial surface 25b of the porous wall 44, can lead to reduced transport cup life and/or gobs G sticking in the conduit 25, causing poor discharge of the gob G from the passage 28. On the other hand, a conduit 25 that is too cold can lead to an excessive or non-uniform loss of thermal energy from the gob G while in the transport cup 12. A conduit 25 that is too cold can cause the gob G to contract away from the radially inner surface 25b of the conduit, which in turn causes non-uniform heat loss from the gob even if the contraction results in less thermal energy being extracted from the gob G. A non-limiting example of a suitable temperature range for the radially inner surface 25b of the porous wall 44 after the cooling period E is from 250° C. to 400° C., from 250° C. to 450° C., or from 320° C. to 390° C.

Non-uniform heat loss from the gob G due to a relatively cool conduit 25 can be detected by the image sensor(s) 14, 16 when the gob G is subsequently discharged from the transport cup 12 and may be indicated by wrinkles in the thermal profile. Accordingly, embodiments of a method may include adjusting the duration of the cooling period E and/or the initial cooling gas flowrate F1i based on a thermal characteristic of a discharged gob G. In particular, the duration of the cooling period E and/or the initial cooling gas flowrate F1i may be decreased based on a non-uniform temperature profile obtained from a discharged gob G.

FIG. 10 depicts an illustrative method combining features of the methods of FIGS. 4 and 9 along with other above-described features. The illustrated process cycle starts at the beginning of period A and ends at the end of period D of FIG. 3. The method includes obtaining a temperature of the transport cup 12 at the receiving location (step 410), closing the endcap 22 of the transport cup 12 and setting the flowrates of the cooling gas and endcap fluid flows F1, F2 to their initial flowrates F1i, F2i (if those conditions are not already met) (step 414), receiving a glass gob G in the transport cup 12 (step 416), reducing the flowrate of the endcap fluid flow F2 to the secondary endcap flowrate F2s (step 420), moving the transport cup 12 to the discharge location (step 422), reducing the flowrate of the cooling gas flow F1 to the secondary cooling gas flowrate F1s and moving the endcap 22 to the open position (step 424), observing the discharged gob G (step 426), increasing the flowrate of the cooling gas flow F1 to the initial cooling gas flowrate F1i (step 432), and moving the transport cup 12 back to the receiving location (step 434). The illustrated method also includes updating the cooling gas flow profile 52 (step 412) based on the temperature obtained in step 410, verifying receipt of the gob G into the transport cup 12 (step 418) during step 416, verifying discharge of the gob G (step 428) during step 426, and updating the cooling gas flow profile 52 and endcap fluid flow profile 54 (step 430) based on the observation(s) of step 426.

Some of the steps illustrated in FIG. 10 are equivalent to those of FIGS. 4 and 9, and others related to other figures and the above description of the glass gob delivery system 10. For example, steps 410 and 412 are consistent with steps 310 and 312 of FIG. 8, while steps 426 and 430 are consistent with steps 210 and 212 of FIG. 4. In the steps where the flowrate of the cooling gas flow F1 or the flowrate of the endcap fluid flow F2 is changed between initial flowrates F1i, F2i and secondary flowrates F1s, F2s, those flowrates are based on the latest flow profile updates of steps 412 and 430.

Each updated fluid flow profile 52, 54 may also include adjustments to transition timing between initial and secondary flowrates F1s, F2s, and some of the illustrated steps may overlap in time. For example, the reduction in the flowrate of the endcap fluid flow F2 from the initial endcap fluid flowrate F2i to the secondary endcap fluid flowrate F2s in step 420 may be initiated during receipt of the gob G in step 416. Similarly, the reduction in the flowrate of the cooling gas flow F1 from the initial cooling gas flowrate F1i to the secondary cooling gas flowrate F1s may be initiated during movement of the transport cup 12 from the receiving location to the discharge location in step 422. The timing of the transition from the secondary flowrates F1s, F2s to the initial cooling gas flowrates F1i, F2i (step 432) after gob discharge in step 426 may overlap in time with cup movement toward the receiving location in step 434. Also, while the opening of the endcap 22 to the open position and the reduction in flowrate of the cooling gas flow F1 to the secondary cooling gas flowrate F1s are both part of step 424 to initiate the discharge of the gob G, their timing may not be simultaneous. The flowrate of the cooling gas flow F1 may be reduced before the endcap 22 is opened, for example.

The illustrated method 400 may be automated and iterative via the process controller 38. However, the illustrated method can also be performed by a user without the aid of a processor. For example, a user may perform the illustrated method as part of a gob delivery system set-up procedure. In that case, it may be useful to iterate individual fluid flow parameters to achieve the desired results rather than simultaneously adjust more than one fluid flow parameter for each new process cycle as a process controller may do.

In one embodiment, cooling gas flow profile 52 is first adjusted to ensure that the radially inner surface 25b of the porous wall 44 of the conduit 25 is within the desired temperature range when arriving at the receiving location after discharging a glass gob G. In a practical example, the initial cooling gas flow rate F1i is at maximum line pressure of the glass container manufacturing facility (e.g., 85-100 psi), and the user repeatedly adjusts the time period E (FIG. 3), without adjusting the initial cooling gas flowrate F1i, until the transport cup 12 arrives at the receiving location within the desired temperature range. Here, the user omits the other steps of the method of FIG. 10 and is essentially performing the method of FIG. 9.

Once the proper cooling period E is obtained, the user may then make adjustments to the endcap fluid flow profile 54 based on observations of discharged glass gobs G by the optical and thermal image sensors 14, 16. The user can review the optical and thermal images of each discharged gob G and adjust endcap fluid flow parameters based on characteristics of the gob G that are apparent in the images. These adjustments can be consistent with those described above in conjunction with FIG. 4. The user may work toward achieving the slightly radiused nose N of FIG. 5 by adjusting the initial and secondary endcap fluid flowrates F2i, F2s such that the initial endcap fluid flowrate F2i slows the gob G entering the transport cup 12 enough to permit contact of the gob G with the endcap 22 without excessive velocity, or to permit no contact at all, so that the gob G is not forced back out of the conduit 25 at least partially past inlet 15 of the passage 28 of the conduit 25. This part of the process set-up also includes adjusting the secondary endcap fluid flowrate F2s to achieve a fluidic cushion between the endcap 22 and the gob G during movement toward the discharge location.

Once the proper endcap fluid flow profile 54 is obtained, the user may then make additional adjustments to the cooling gas flow profile 52 based on observations of discharged glass gobs G by the optical camera 14. This time, the adjustments may be focused on the secondary cooling gas flowrate F1s and/or the timing of the cooling gas flowrate transition from the initial cooling gas flowrate F1i to the secondary cooling gas flowrate F1s. The secondary cooling gas flowrate F1s may be indirectly adjusted by regulating the pressure of the cooling gas in the cooling chamber 26 down to a fraction (e.g., less than 10%) of the maximum line pressure. These adjustments can also be consistent with those described above in conjunction with FIG. 4. For example, the user can review the optical images of each discharged gob G and iteratively adjust the secondary cooling gas flowrate F1s to maximize the diameter D of the observed gob G without causing the gob G to stick to the conduit 25 within the passage 28 or otherwise cause a late gob delivery.

In some embodiments, adjustments are made to the transport cup fluid flow parameters based on observations of a plurality of discharged gobs G. For example, multiple process cycles may be carried out with the same cooling gas flow profile 52 and endcap fluid flow profile 54 during which images of each discharged gob G are obtained by the image sensor(s) 14, 16. The characteristic of interest (e.g., diameter, thermal profile, etc.) can then be averaged for the multiple gobs G received, transported, and discharged using the same flow profiles 52, 54, and adjustments to the appropriate fluid flow profile can be made based on that average. This technique can be used during the process set-up procedure or during automated operation of the gob delivery system 10. The process controller 38 may, for example, maintain a running average for each observed gob characteristic over a previous plurality of discharged gobs G and adjust or update transport cup fluid flow parameters based on the running averages.

As used in herein, the terminology “for example,” “e.g.,” “for instance,” “like,” “such as,” “comprising,” “having,” “including,” and the like, when used with a listing of one or more elements, is to be construed as open-ended, meaning that the listing does not exclude additional elements. Also, as used herein, the term “may” is an expedient merely to indicate optionality, for instance, of a disclosed embodiment, element, feature, or the like, and should not be construed as rendering indefinite any disclosure herein. Moreover, directional words such as front, rear, top, bottom, upper, lower, radial, circumferential, axial, lateral, longitudinal, vertical, horizontal, transverse, and/or the like are employed by way of example and not necessarily limitation.

Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. And for the sake of expedience, each explicit illustrative embodiment and modification is hereby incorporated by reference into one or more of the other explicit illustrative embodiments and modifications. As such, many other embodiments, modifications, and equivalents thereto, either exist now or are yet to be discovered and, thus, it is neither intended nor possible to presently describe all such subject matter, which will readily be suggested to persons of ordinary skill in the art in view of the present disclosure. Rather, the present disclosure is intended to embrace all such embodiments and modifications of the subject matter of this application, and equivalents thereto, as fall within the broad scope of the accompanying claims.

1. A method, comprising:
(a) observing a molten glass gob discharged from a molten glass transport cup; and
(b) adjusting a fluid flow parameter of the transport cup based on a characteristic of the discharged glass gob observed in step (a).

2. The method of claim 1, further comprising the step of obtaining an image of the glass gob in step (a), wherein the image is indicative of said characteristic.

3. The method of claim 1, wherein said characteristic is a diameter of the glass gob, and the fluid flow parameter is a transport cup cooling gas flow profile.

4. The method of claim 1, wherein said characteristic is a uniformity of a diameter of the glass gob, and the fluid flow parameter is a transport cup endcap fluid flow profile.

5. The method of claim 1, wherein said characteristic is a shape of a nose of the glass gob, and the fluid flow parameter is a transport cup endcap fluid flow profile.

6. The method of claim 1, wherein said characteristic is a temperature of the glass gob, and the fluid flow parameter is a transport cup endcap fluid flow profile.

7. The method of claim 1, wherein said characteristic is a timing of the discharge of the glass gob from the transport cup, and the fluid flow parameter is a transport cup endcap fluid flow profile.

8. The method of claim 1, further comprising:
adjusting a transport cup cooling gas flow profile based on a temperature of the transport cup measured after step (a) and before the transport cup receives a subsequent glass gob.

9. The method of claim 8, wherein the step of adjusting includes adjusting a duration of a cooling period after the transport cup discharges the subsequent glass gob.

10. A method, comprising the steps of:
(a) observing a characteristic of a first glass gob discharged from a molten glass transport cup at a glass gob discharge location;
(b) moving the transport cup to a glass gob receiving location after step (a);
(c) measuring a temperature of the transport cup after step (a);
(d) receiving a second glass gob in the transport cup at the receiving location after step (b);
(e) moving the transport cup containing the second glass gob to the discharge location after step (d);
(f) discharging the second glass gob from the transport cup after step (e); and
(g) moving the transport cup to the receiving location after step (f),
wherein a fluid flow parameter of the transport cup during at least one of steps (d) through (g) is regulated based on at least one of: the temperature measured in step (c), and the characteristic observed in step (a).

11. The method of claim 10, wherein the fluid flow parameter is a transport cup cooling gas flow profile during step (g) based on the temperature measured in step (c).

12. The method of claim 10, wherein the fluid flow parameter is an endcap fluid flow profile from an endcap of the transport cup during step (d) based on the characteristic observed in step (a), the characteristic being a shape of the first glass gob.

13. The method of claim 10, wherein the fluid flow parameter is an endcap fluid flow profile from an endcap of the transport cup during step (d) based on the characteristic observed in step (a), the characteristic being a temperature of the first glass gob.

14. The method of claim 10, wherein the fluid flow parameter is at least one of an initial endcap fluid flowrate, a secondary endcap fluid flowrate, or a duration of the initial endcap fluid flowrate through an endcap of the transport cup during step (d) based on the characteristic observed in step (a).

15. The method of claim 10, wherein the fluid flow parameter is a cooling gas flow profile through a porous wall of the transport cup during step (e) and before step (f) based on the characteristic observed in step (a), the characteristic being a shape of the first glass gob.

16. The method of claim 15, wherein at least one of an initial cooling gas flowrate, a secondary cooling gas flowrate, and a timing of a change from the initial flowrate to the secondary flowrate of the cooling gas flow profile is regulated based on the shape of the first glass gob.

17. A glass gob delivery system, comprising:
a transport cup that moves back and forth between a glass gob receiving location and a glass gob discharge location, the transport cup comprising
a porous wall at least partly defining a passage of the transport cup, and
an endcap that covers an outlet of the passage at the receiving location and uncovers the outlet of the passage at the discharge location; and
a camera that obtains an image indicative of a characteristic of a glass gob being discharged from the passage at the discharge location,
wherein a cooling gas flowrate into the passage through the porous wall and an endcap fluid flowrate into the passage through the endcap during receipt of a different glass gob into the transport cup at the receiving location is based at least in part on said characteristic.

18. The glass gob delivery system of claim 17, wherein the camera is an optical camera and said characteristic is a shape of the glass gob in the image.

19. The glass gob delivery system of claim 17, wherein the camera is a thermal camera and said characteristic is a temperature of the glass gob in the image.

20. The glass gob delivery system of claim 17, wherein the transport cup further comprises a cooling chamber adapted for fluidic communication with a cooling gas source, the cooling gas flowrate being a cooling gas flowrate from the cooling chamber and through the porous wall of the transport cup.

21. The glass gob delivery system of claim 17, wherein the transport cup further comprises fluid passages formed through the endcap and adapted for fluidic communication with a gas source, the endcap fluid flowrate being a gas flowrate through the endcap and into the transport cup passage.

22. The glass gob delivery system of claim 17, further comprising a cooling gas controller that regulates the cooling gas flow while each glass gob is in the transport cup based on the characteristic indicated by the image obtained by the camera.

23. The glass gob delivery system of claim 17, further comprising an endcap fluid flow controller that regulates the endcap fluid flow while the transport cup is receiving a glass gob at the receiving location based on the characteristic indicated by the image obtained by the camera.

24. The glass gob delivery system of claim 17, further comprising a gob receiving sensor that detects receipt of each glass gob into the transport cup.

25. The glass gob delivery system of claim 17, further comprising a gob discharge sensor that detects discharge of each glass gob from the transport cup.

26. The glass gob delivery system of claim 25, wherein the gob discharge sensor is arranged to observe the discharge of each glass gob through a gap between the endcap and the porous wall.
